(19) United States
(12) Patent Application Publication
(10) Pub. No.: US 2009/0210197 A1
(43) Pub. Date: Aug. 20, 2009

(54) DATA ACCESSING SYSTEM AND METHOD

(75) Inventor: Simon Cleary, Victoria (AU)

Correspondence Address: SCHWEGMAN, LUNDBERG & WOESSNER, P.A., P.O. BOX 2938, MINNEAPOLIS, MN, 55402, US

(73) Assignee: INTELEMETRIX LTD, MALVERN, VICTORIA (AU)

(21) Appl. No.: 12/301,726

(22) PCT Filed: May 23, 2007
(86) PCT No.: PCT/AU2007/000706

§ 371 Date: Apr. 14, 2009

(30) Foreign Application Priority Data
May 23, 2006 (AU) 2006902772

(51) Int. Cl. G06F 17/40

(52) U.S. Cl. 702/187

(57) ABSTRACT

A system for accessing and collecting data from a utility meter comprising a data reading means for reading the data from the utility meter and temporarily storing the data, data collector means for receiving the temporarily stored data from the data reading means and data storage means for permanently storing the data which is transmitted from the data collector means. A first communications network is used to transmit the data from the data reading means to the data collector means and a second communications network is used to transmit the data from the data collector means to the data storage means.

### CROSS-REFERENCE TO RELATED APPLICATIONS

The present application claims priority from Australian Provisional Patent Application No 2006902772 filed on 23 May 2006, the content of which is incorporated herein by reference.

### FIELD OF THE INVENTION

This invention relates to a data accessing method and system and more particularly to a method and system for accessing data from a utility meter, such as electricity meters, gas meters and water meters. The method and system of the invention is able to read and collect data from existing utility meters without the need for replacing such meters.

### BACKGROUND TO THE INVENTION

Existing meter systems for utilities such as gas, water and electricity are either mechanical meters or digital readout meters. Mechanical meters show the usage or consumption over a period of time (interval meter data) through mechanical dials. The amounts of consumption are then manually read at a particular time and fed into a database for subsequent billing to the premises where the meter was read. Portable database or storage units such as person digital assistants (PDA) may be used to enter the amounts which are then subsequently transferred into a billing database. However these traditional mechanical meters provide no particular mechanism for remotely reading a meter and do not provide an ability to store interval meter data.

Digital meters are capable of storing accumulated usage or consumption, in terms of the amount of utility used, as well as interval metering data. Early versions of the digital meters did not have the ability to be remotely read and required the use of hand held data loggers, or PDAs, to interrogate the meters through their data ports in order to collect the readings from the meter. Often an optical data port subject to standard IEC 1107 was required. The remote reading of such digital meter systems is often implemented by SCARDA Building Management Systems. The use of optical data readers is an expensive solution in order to read the data from the meters.

Further development of digital meters has resulted in the ability to remotely read meters via the use of RF modules or GPRS-based modems or dial-up modems. However, these systems are substantially more expensive than a digital meter on its own, requiring a communication module per meter to enable such remote interrogation. This is clearly a much more expensive implementation for reading the data.

The present invention seeks to overcome one or more of the above disadvantages by providing a data accessing method and system for accessing data from utility meters where the utility meter does not need to be replaced. Furthermore, interval metering data can be remotely accessed for local storage at the reader and then be transmitted to a further processing centre.

### SUMMARY OF THE INVENTION

According to a first aspect of the invention there is provided a system for accessing and collecting data from a utility meter comprising:

data reading means for reading the data from the utility meter and temporarily storing the data;

data collector means for receiving the temporarily stored data from the data reading means; and

data storage means for permanently storing the data which is transmitted from the data collector means;

wherein a first communications network is used to transmit the data from the data reading means to the data collector means and a second communications network is used to transmit the data from the data collector means to the data storage means.

The data reading means is preferably in the form of one or more data loggers. The first communications network between the data reading means and the data collector means is either a fixed wireline network or a wireless network. The second communications network between the data collector means and the data storage means may be a fixed wireline network or a wireless network, such as a radio telecommunications network.

Each data logger may have a series of modules, such as a data reading module, a microprocessor module and a communications interface module. Each of the modules may be stacked together using one printed circuit board.

The utility meter may be any one of a gas meter, electricity meter, water meter, flow meter, pressure meter or temperature meter. The data reading module may also read temperature data and humidity data from the meter and detect tampering to the meter. Where the meter is an electrical/mechanical meter having a rotating disc and an indication band on the rotating disc, an LED transmitter and photo detector unit, forming part of the data reading module, may be used to read the number of passes of the indication band on the disc for a period of time. The total number of passes may represent a count from which is derived usage of the utility. The LED transmitter may be a surface mount ultraviolet LED transmitter and the photo detector may be a surface mount ultraviolet photo detector.

Where the meters are digital meters, an optical serial port on such meters may be read optically to retrieve the meter data, which may include interval meter data.

Actual accumulation usage may be read from the meter by the data reading module and stored locally in a data logger memory. The data stored in the data logger memory may be subsequently transmitted to the data collector means for storage in a data collector means memory and then transmitted for storage in the data storage means, prior to being permanently stored in the data storage means.

The data reading module of the one or more data loggers may record the number of revolutions of the indication band on the rotating disc and store the count, wherein further the count may be used to determine a new accumulation usage and provide the interval meter data. The interval meter data may be transmitted to the data collector means and then to the data storage means, the interval meter data preferably providing a figure for the interval usage over the period of time and is used to update the system.

The data logger memory may be accessed by either the data logger microprocessor module or the data logger data reading module.

In order to detect flow of a fluid through a fluid meter, preferably a reed switch rotates in the flow and each rotation or revolution of the reed switch generates a pulse that is counted and recorded by the data reading module.

According to a second aspect of the invention there is provided a method of accessing and collecting data from a utility meter comprising:

reading the data from the utility meter using a data reader means;

storing the read data temporarily in the data reader means;

transmitting the stored data from the data reader means to a data collector means using a first communications network;

thereafter transmitting the data from the data collector means to a data storage means using a second communications network for permanent storage.

Where the data reading means is one or more data loggers, one or more of the data loggers including a data reading module having a LED transmitter and photo detector unit, the meter being an electrical/mechanical meter having a rotating disc and an indication band on the rotating disc, the method may further comprise reading the number of passes of the indication band on the disc for a period of time as the disc rotates, the total number of passes preferably representing a count from which is derived usage of the utility.

The method may further comprise reading actual accumulation usage from the meter using the data reading module and storing the actual accumulation usage in a data logger memory.

The method may further comprise transmitting the usage data in the data logger memory to the data collector means and storing the usage data in a data collector means memory prior to permanently storing the data in the data storage means.

### BRIEF DESCRIPTION OF THE DRAWINGS

Preferred embodiments of the invention will hereinafter be described, by way of example only, with reference to the drawings wherein:

FIG. 1 is a block diagram of a system according to an embodiment of the invention for accessing and collecting data from a utility meter; and

FIG. 2 is a block diagram showing further detailed components of a data logger used as part of the system of FIG. 1.

### DETAILED DESCRIPTION OF THE PREFERRED EMBODIMENTS

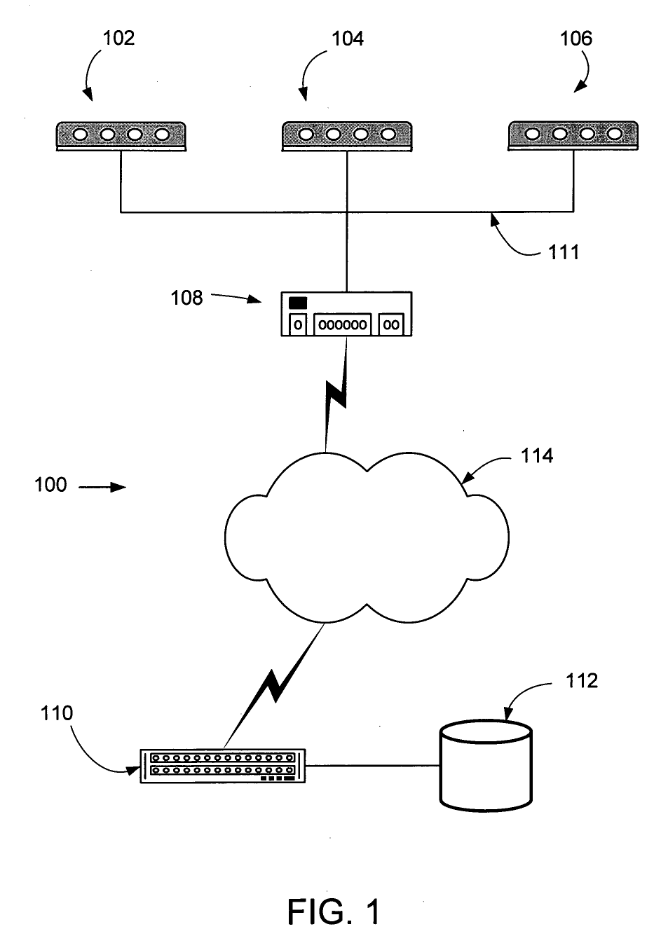

With reference to FIG. 1 there is shown a system 100 for reading and collecting data from a utility meter, such as a gas meter, water meter or electricity meter. It includes a series of data reading means in the form of data loggers 102, 104 and 106 for respectively each reading a utility meter. Each data logger is physically attached to the meter head from which it is reading data. Each of the data loggers 102, 104 and 106 are linked to a data collector 108 either by wireline or wireless networks. Connectivity between each data logger and the data collector 108 is through a communication bus/protocol system, such as RS585, Multidrop RS323 or CANBUS. A common cable 111 enables such connectivity and power to be delivered to each data logger from the data collector, which also acts as the master on the bus. Alternatively, a mobile communications network may be used over which communication between each data logger 102, 104, 106 and the data collector is made. A USB port on the data collector 108 is used to configure the data collector 108 at installation time. Communication between the data collector 108 and the data loggers 102, 104 and 106 also enables each data logger 102, 104, 106 to be configured at installation time. The data collector 108 is linked to a data storage module 110 which in turn is linked to a database 112. The data collector 108 is linked to the data storage module 110 through a communications network 114 such as a radio communications network. Alternatively the network 114 may be a wireline network such as the PSTN.

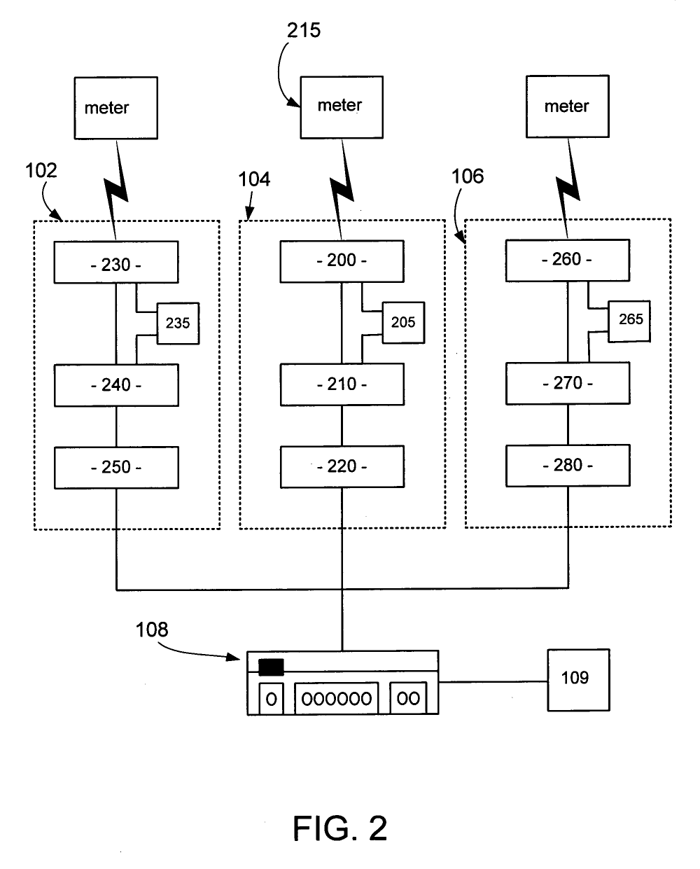

With reference to FIG. 2 each of the data loggers 102, 104 and 106 comprises three modules. Thus for example with reference to data logger 104 it includes a data reading module 200, a data logger memory 205, a microprocessor module 210 and a communications interface module 220. Similarly data logger 102 has a data reader module 230, a data logger memory 235, a microprocessor module 240 and a communications interface module 250 whilst data logger 106 has a data reader module 260, a data logger memory 265, a microprocessor module 270 and a communications interface module 280. As many data loggers as are required can be used to respectively read a meter and obtain data from the meter and send the retrieved data to the data collector 108. Each of the modules of the data logger is stackable and other stackable modules may be used within the stack such as an external power supply module, with battery back up, or environmental sensor modules which sense temperature, humidity and daylight at the time of reading a respective meter. Information derived from the environmental sensor modules is then stored temporarily in the data logger 104 and forwarded to the data collector 108.

Any reference to the data logger 104 and its components is also applicable to the data loggers 102, 106 and their respective components. The data reading module 200 collects the data from the meter 215 either through a serial port, optical readers or photo LEDs and photo detectors. Thus communication between the data reader 200 and the meter 215 is done either wirelessly or by wire. Other data can also be retrieved by the data reading module 200 such as temperature, humidity and evidence of tampering.

With regard to older style mechanical/electrical meters they are of the construction having a rotating disc with an indication band on the disc and analog dials to indicate the amount of utility consumed. The data reading module 200 is fitted with a photo LED and a photo detector. The data logger 104 is held within the vicinity of the meter to be read and the LED is shone onto the edge of the rotating disc. The disc is normally made from aluminium and has a black indication band and as the disk rotates a count is made, via the photo detector, of each passing of indication band for a nominated period of time. The photo detector is used to measure the reflected light, emanating from the aluminium as a result of the LED shining onto it. A count is detected when the intensity of the light reflected moves from high to low. This will happen when the black indication band passes through the path of the LED light as the black indication band will not reflect as much light as is normally reflected from the remainder of the aluminium rotating disc.

There are many different types of mechanical/electrical meters, each type having a different “revolutions to Kwh” ratio of their rotating disc. Some ratios are as high as 300 revs per KWh and as low as 66.6 revs per Kwh. On average a rotating disc is 40 mm in diameter and the black indication band is approximately 10 mm. An appropriate sample rate to ensure detection of the black indication band is greater than 25 Hz. To ensure appropriate edge detection, the data reader will over sample the data at 100 Hz.

Optical components have a limited life in terms of usage thus the optical transmitter LED incorporated in the data reading module 200 will only be switched on for the sample period. This extends its usable life and the turning on and off is controllable by the microprocessor module 210.

The LED transmitter and the photo detector preferably transmit and detect in the ultraviolet part of the spectrum. In particular it is preferable that surface mount ultraviolet LEDs and surface mount ultraviolet photo detectors are used. This provides a more robust solution and a better alternative to the use of infrared transmitters and photo detectors which can be prone to interference. Appropriate amplification of the detected light can enhance the detection through operational amplifiers in the data reading module 200.

Thus in practice, a reading of the actual accumulated usage of the meter is taken by the data reading module 200 and stored locally in the data logger memory 205 of the data logger 104 and also in a data collector memory 109 associated with the data collector 108, on transmission from the data logger 104. The data logger then records the number of pulses or counts the number of times the indication band revolves. With this particular count stored it is now possible to determine the new accumulated usage to provide an interval data reading. The data store 110 already has stored an accumulated total from a particular meter and thus the interval totals in the form of counts, pulses or disc rotations is all that is needed to update the system when it is transmitted from the data logger 104 to the data collector 108 and then to the data storage module 110. This provides the figure for the interval consumption over a period of time. It is possible to request a check on the accumulated data stored at the data logger 104 and data collector 108 which can be updated when required. This will usually happen if there is a “slippage” on the readings where they do compare identically.

With regard to the digital electric meters the data reading head or module 200 reads the data from the meter 215 using an optical serial port, specifically an IRDA port consisting of an infrared transmitter and receiver diode. These are driven the same way as the transmit and receive lines of an RS232 serial port. Cross over is accomplished optically instead of electrically and the start and stop bits employed in a UART are similar to that in the RS232 except that there is an infrared optical link carrying the pulses. A protocol IEC 1107 manages the baud selection rate and the request and acknowledgement sequences. Interrogation of the digital meters is made through the RS232 like interface. Thus the information is read serially using the IRDA port.

For detecting the flow of water or gas through a water or gas meter a reed switch is used. The reed switch rotates within the flow of the water or gas and each rotation of the reed switch closes a contact. A voltage current source is used through the reed switch and back to the detector. Each rotation generates a pulse that is recorded and counted.

With regard to the microprocessor module 210 it contains not only a microprocessor but a real time clock with battery back up and a local data storage unit (serial data flash), that may be separate to memory 205. The microprocessor module 210 is able to collect, maintain and store interval data from the data reader module 200 and is then able to transfer that data to the data collector 108 through the communications interface 220. By using a real time clock with a battery backup the microprocessor is able to maintain a time stamp for all of the data values. Thus with battery backup the time stamp used will be correct even when power has been lost to the microprocessor. As the data is locally stored in the data logger 104, it is able to maintain data integrity of metered data even while connectivity to the data collector 108 or central data storage 110 is interrupted. In the local data storage 205 of the data logger 104 it is possible to maintain storage for multiple electrical registers per electric meter, that is peak readings, off-peak readings from the one digital meter, associated meter serial numbers, national meter identification number and accumulated totals. Other data such as system alarms, power outages, tamper alarms or temperature and humidity readings may also be stored in the data logger memory 205.

The microprocessor runs a small embedded program that maintains the sampling of data, storage requirements, time stamps, alarm conditions and communication of the data to other modules. The microprocessor module ensures that communication between the data logger 104 and the data collector 108 has an acknowledgement state to ensure reliable predictable transfer of data. Thus the data collector 108 on receipt of data from the data logger 104 will send an acknowledgement signal to the microprocessor 210. This ensures that the local data storage 205 is only able to erase stored values once they have been acknowledged as having been captured by upstream modules such as the data collector 108 or the data storage unit 110. Other requirements may have been placed on the microprocessor and module such as the minimum number of days required to maintain the data, serial numbers and accumulated totals etc. The actual size of the data is determined by the size of serial data flash used which is selected and determined during a commercialisation stage and driven by business and regulatory requirements.

The microprocessor code is programmable and can be customised to meet the requirements of various data reading modules, communication modules and other modules that may be used as part of the overall system.

The microprocessor module 210 has a single connector line along each of the opposite sides on a printed circuit board and also a single connector line along each of the top surface and bottom surface of the PCB. These connectors form the basis of stackable pins that are used in the data logger, that is, provides the basis for stacking the data reading module 200, microprocessor module 210 and communications interface 220. Thus it is through these pin connectors that communication occurs between the modules. It is also where the power for each of the modules is sourced as all modules share the stackable pins and are common to each board. The input and output pins to and from the microprocessor module 210 support three wire serial parallel interface (SPI), two wire I2C, two serial ports, JTAG, sensor on, sensor return and tamper detect. To accommodate future expansion of connections to the module there are also some spare 10 pins. The stackable modules are general small, typically 35 mm by 40 mm but may even be smaller in size. All microprocessor modules have a unique hardware based identification number, to assist in deployment, installation and support of the metering system.

The microprocessor module 210 is responsible for sampling a returned intensity of reflected light which is provided from the data reading module 200 and is responsible for determining the entry and exiting of the black indication band. Each passing is denoted as a rotation count. With regard to the sampling rate, a programmable solution can be developed to address the exact sample rates required dependent upon the type of meter by using appropriate analog to digital converter sample rates in the microprocessor module 210.

The data stored by the data logger memory 205, which can be accessed either by the data reading module 200 or the microprocessor module 210, may be transmitted to the data collector 108 at regular intervals or when requested by the data collector 108 through suitable protocols. In order to achieve this the communications interface module 220 is used by the microprocessor module 210. There are two possible types of communication interface module, either a module that interfaces to a wireline system or a module that interfaces to a wireless system.

The wireline system is part of a bus topology that links all of the data loggers through the common cable 111 with communication protocol drivers. A commercial protocol available is CANBUS, which provides predictable and controllable communications between the data collector 108 and the data loggers 102, 104 and 106. Apart from data communications, the bus topology enables power to be supplied to the data loggers permitting battery backup to be provided by the data collector 108. The CANBUS protocol module forms part of the stackable modules.

Regarding a wireless system, a commercial RF chipset can be used to provide a wireless mesh solution that enables data to be transmitted between the data loggers 102, 104 and 106 and the data collector 108. The data logger 104 and the data collector 108 support “receive and transmit capabilities” which ensures reliable acknowledgeable data transfer. An embedded microprocessor board in the data logger 104 enables the system to establish a distributed wireless network, which is embedded in each of the microprocessor modules of the respective data loggers. The wireless version supports a variety of RF solutions such as Zigbee or Chipcon. The chipset solution depends upon the environment in which the system is deployed and the costs associated with the deployment and running of the system. The wireless system utilises a local power supply with a battery backup module in use with each of the data loggers. Such a system has been designed for a low power usage.

With regard to the data collector 108 this is a hub for all data loggers located in a particular region. The number of data loggers that can be connected to a single data collector 108 is limited by the length of cable used. The CANBUS system has a physical limit on the length of cable that can be used. Using a wireless network, the number of data loggers that can be used is governed by the RF receive and transmit power.

The data collector 108 collects and stores in data collector memory 109 information from all the data reading modules in the data loggers and performs pre-processing before transmitting the data to a central data processing centre through data store 110 and database 112 over a communications network 114. The network 114 may be wireless and use standard communication protocols such as GSM (GPRS), Ethernet or rather than being wireless can use the PSTN. It may also be the internet with appropriate internet protocols using dial-up, ethernet or GPRS modules.

The data collector 108 consists of three modules, being an embedded microprocessor module, a communications module supporting Ethernet or GPRS modem and a power supply module. A single data collector 108 is capable of handling multiple wired or wireless IDC units. The data collector 108 supervises power supply to each of the data loggers and when required, the data collector 108 ensures that power supply is maintained during any power outage by its battery backup system.

Regarding the data storage module 110, incoming data from the various data loggers and through the data collector 108 is stored and analysed. An SQL database 112 is used to house the collected data which can then be interrogated and manipulated for various purposes. The data is also used for monitoring and maintaining the data loggers and data collectors. Along with consumption data, the data store 110 contains data on error rates, power supply status, power outages and battery status of the equipment.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-26. (canceled)

27. A system for automatically collecting metering data from a variety of meter devices comprising:
a series of data loggers for reading the metering data, , wherein each data logger has an adaptable data reading module to suit and fit to a specific meter device from which metering data is read;
a data collector for receiving the metering data from all the data loggers; and
a data storage device for permanently storing the metering data which is transmitted from the data collector;
wherein a first communications network is used to collectively transmit the metering data from all data loggers to the data collector and a second communications network is used to transmit the metering data from the data collector to the data storage device.

28. A system according to claim 27 wherein the first communications network between the data loggers and the data collector is a fixed wireline network or a wireless network.

29. A system according to claim 28 wherein where the first communications network between the data loggers and the data collector is a fixed wireline network, power is delivered to each data logger from the data collector.

30. A system according to claim 27 wherein the second communications network between the data collector the data storage device is a fixed wireline network or a wireless network.

31. A system according to claim 30 wherein the data reading module of each of the data loggers is attached to a meter head of the respective meter devices in order to read data from the meter devices.

32. A system according to claim 30 wherein each data logger has a series of modules including the data reading module, a microprocessor module and a communications interface module.

33. A system according to claim 32 wherein each of the data reading module, microprocessor module and communications interface module are stacked together using one printed circuit board and each of the modules is able to be changed to suit the meter device being read and to suit the communications network used.

34. A system according to claim 33 wherein the data reading module is connectable to the microprocessor module.

35. A system according to claim 34 wherein the communications interface module is interchangeable depending on the type of first communications network used and the data collector is able to communicate with a variety of communication interface modules.

36. A system according to claim 35 wherein the data collector communicates with a variety of communication interface modules in each data logger.

37. A system according to claim 36 wherein the data collector consists of a number of modules with each module of the data collector being interchangeable to suit data logger communications topology, data storage, power distribution, battery backup and communications with the data storage device.

38. A system according to claim 37 wherein metering data is temporarily stored in a respective data logger.

39. A system according to claim 32 wherein each data logger, through the data reading module, is able to read the utility meter data, temperature data, humidity data and detect tampering to the meter.

40. A system according to claim 32 wherein the meter device is any one of a gas meter, electricity meter, water meter, flow meter, pressure meter or temperature meter.

41. A system according to claim 32 wherein the meter device is an electrical/mechanical meter having a rotating disc and an indication band on the rotating disc.

42. A system according to claim 41 wherein an LED transmitter and photo detector unit are included in the data reading module and are used to read the number of passes of the indication band on the disc for a period of time as the disc rotates, the total number of passes representing a count from which is derived usage of the characteristic being metered.

43. A system according to claim 32 wherein the LED transmitter is a surface mount ultraviolet LED transmitter and the photo detector is a surface mount ultraviolet photo detector.

44. A system according to claim 6 wherein the meter device is a digital meter and an optical serial port on the meter is read optically to retrieve the metering data, which includes interval metering data.

45. A system according to claim 32 wherein actual accumulation usage is read from the meter device by the data reading module and stored locally in a data logger memory.

46. A system according to claim 45 wherein the data stored in the data logger memory is subsequently transmitted to the data collector for storage in a data collector memory and then transmitted for storage in the data storage device, prior to being permanently stored in the data storage device.

47. A system according to claim 46 wherein the data reading module of the one or more data loggers records the number of revolutions of the indication band on the rotating disc and stores the count, wherein further the count is used to determine a new accumulation usage and provide an interval metering data.

48. A system according to claim 47 wherein the interval metering data is transmitted to the data collector and then to the data storage device, the interval metering data providing a figure for the interval usage over the period of time and is used to update the system.

49. A system according to claim 48 wherein the data logger memory is accessed by the data logger microprocessor module or the data logger data reading module.

50. A system according to claim 27 wherein in order to detect flow of a fluid through a fluid meter, a reed switch rotates in the flow and each rotation or revolution of the reed switch generates a pulse that is counted and recorded by the data reading module.

51. A method of automatically collecting metering data from a variety of meter devices comprising:
reading the metering data from the meter devices using a series of data loggers, wherein each data logger has an adaptable data reading module to suit and fit a specific meter device from which metering data is read;
transmitting the metering data from all of the data loggers to a data collector using a first communications network;
thereafter transmitting the metering data from the data collector to a data storage device using a second communications network for permanent storage in the data storage device.

52. A method according to claim 51 wherein where the data reading module includes a LED transmitter and photo detector unit, and the meter device is an electrical/mechanical meter having a rotating disc and an indication band on the rotating disc, the method further comprises:
reading the number of passes of the indication band on the disc for a period of time as the disc rotates, the total number of passes representing a count from which is derived usage of the utility.

53. A method according to claim 52 further comprising: reading actual accumulation usage from the meter device using the data reading module, and storing the actual accumulation usage as usage data in a data logger memory.

54. A method according to claim 53 further comprising: transmitting the usage data in the data logger memory to the data collector;
storing the usage data in a data collector memory prior to permanently storing the data in the data storage device.

55. A method according to claim 54 further comprising:
the data reading module of the one or more data loggers recording the number of revolutions of the indication band on the rotating disc and storing the count, wherein further the count is used to determine a new accumulation usage and provide an interval metering data.

56. A method according to claim 55 further comprising:
transmitting the interval metering data to the data collector and subsequently transmitting the interval metering data to the data storage device, the interval metering data providing a figure for the interval usage over the period of time and is used to update the system.

57. A system according to claim 27 wherein each of the data loggers communicate with one another to collect and collate metering data for transmission to the data collector.
